(19) United States
(12) Patent Application Publication
(10) Pub. No.: US 2011/0101015 A1
(43) Pub. Date: May 5, 2011

(54) Beverage container dispensing apparatus

(76) Inventors: Matthias Bollmus, Waukesha, WI (US); John Schlick, Menomonee Falls, WI (US)

(21) Appl. No.: 12/800,642

(22) Filed: May 19, 2010

Related U.S. Application Data
(60) Provisional application No. 61/216,604, filed on May 19, 2009.

(51) Int. Cl. B65D 83/00; F25D 3/08; B65G 59/02

(52) U.S. Cl. 221/1; 221/249; 221/150 R

(57) ABSTRACT

A beverage dispensing apparatus is shaped like the torso of a sports figure with appropriate head gear. The head gear pivots between an open and closed position. Opening the head gear permits access to beverage containers stacked in rows in a dispensing chamber within the apparatus. A mechanical lifting mechanism is coupled to the head gear. The lifting mechanism lifts a new row of beverage containers upward for access as the head gear is pivoted closed.

### RELATED APPLICATION

This application claims the benefit of U.S. Provisional Patent Application Ser. No. 61/216,604 filed 19 May 2009, and entitled “Beverage Can Dispensing Apparatus,” which is incorporated herein by reference.

### FIELD OF THE INVENTION

The invention generally relates to portable beverage dispensing apparatus.

### BACKGROUND OF THE INVENTION

Individuals or groups of people attending sport events, picnics, fishing, or the like, find it desirable have cold beverages readily available for consumption. A variety of portable containers have been provided for the transportation, storage and removal of cold beverages. Many beverage coolers take the form of an insulated box with a cover and handles for carrying attached to the box. Some coolers are more decorative. Furthermore, some coolers include on-board mechanisms for dispensing the beverage containers on demand.

### SUMMARY OF THE INVENTION

It is an object of the invention to provide a cooling, storage, and dispensing apparatus for beverage containers, which integrates the expression of a decorative theme with functionality. The invention provides a cooling, storage, and dispensing apparatus for beverage containers that includes, in a thematic decorative construction, a manually actuated dispensing mechanism that quickly and conveniently dispenses beverage containers on demand directly into the hands of a user without reliance upon constant tension spring force.

One aspect of the invention provides a portable beverage dispensing apparatus that is shaped like a human torso, e.g., of a sports figure, with appropriate head gear. This thematic decorative construction has functionality, as the head gear pivots between an opened position and a closed position. Opening the head gear permits access to beverage containers stacked in rows in a dispensing chamber within the apparatus. A mechanical lifting mechanism is coupled to the head gear. The lifting mechanism lifts a new row of beverage containers upward for access as the head gear is pivoted from an opened position to a closed position. The lifting mechanism does not rely upon the application of spring tension to lift the beverage containers, but rather applies an upward lifting force only upon demand, e.g., by closing the decorative head gear.

Not relying upon the application of constant tension, the lifting mechanism can be “smart” and selectively apply the lifting force according to the dispensing status of the beverage containers. For example, the lifting mechanism can include linkage that deactivates the lifting action, despite closure of the head gear, until all beverage containers in a given row have been dispensed. Also, the lifting mechanism can include linkage that inactivates the lifting action when the last row of beverage containers has been lifted up for dispensing, signaling that the dispensing chamber needs to be replenished.

### BRIEF DESCRIPTION OF THE DRAWINGS

FIG. 1 is an assembled front perspective view of a frame for a beverage can dispensing apparatus that embodies technical features of the invention.

FIG. 2A is a rear perspective view of the frame shown in FIG. 1, with a back panel that is hinged on the bottom to be dropped open to show the beverage dispensing chamber housed within the frame, and the head gear of the frame raised for dispensing a beverage can from the chamber.

FIG. 2B is a rear perspective view of an alternative embodiment the frame shown in FIG. 2A, with a back panel that is hinged on the side and swung open to show the beverage dispensing chamber housed within the frame, and the head gear of the frame raised for dispensing a beverage can from the chamber.

FIG. 3 is a rear perspective view of the frame shown in FIG. 1, with a back panel that is hinged on the bottom and dropped open to show the beverage dispensing chamber housed within the frame, and the head gear of the frame lowered, thereby lifting the beverages up one level in the chamber for dispensing.

FIG. 4A is a front perspective view of an illustrative beverage can dispensing apparatus like that shown in FIG. 1, having been ornamented to resemble the torso of a football sports figure.

FIGS. 4B, 4C, and 4D are side views of the ornamented beverage can dispensing apparatus shown in FIG. 4A, showing the principle of raising and lowering the head gear to dispense beverage cans.

FIG. 5 is a front perspective view of an illustrative beverage can dispensing apparatus like that shown in FIG. 1, having been ornamented to resemble the torso of a baseball sports figure.

FIG. 6 is a front perspective view of an illustrative beverage can dispensing apparatus like that shown in FIG. 1, having been ornamented to resemble the torso of a racing sports figure.

FIG. 7A is a front perspective view of an illustrative beverage can dispensing apparatus like that shown in FIG. 4A, with a shoulder strap accessory and/or carrying handle for transport by a user.

FIG. 7B is an exploded front perspective view of an illustrative modular beverage can dispensing apparatus, like that shown in FIG. 4A, showing a generic torso frame that can be outfitted with different head gear and different ornamental skins to provide different sport motifs.

FIG. 7C is a front perspective view of an illustrative ornamental skin that can be folded for shipment and storage and that can be fitted on the generic torso frame shown in FIG. 7B at time of use.

FIG. 8 is an exploded front perspective view of illustrative structural and mechanical components for a beverage can dispensing apparatus that embodies technical features of the invention, as also generally shown in FIGS. 1, 2, and 3.

FIG. 9 is a perspective view of a lift platform that can form a part of the beverage can dispensing apparatus shown in FIG. 8.

FIGS. 10A and 10B are, respectively, an exploded top view and a side section view of the lift platform shown in FIG. 9, with the end and middle lift stops in a normally biased extended position.

FIGS. 11A and 11B are, respectively, an exploded top view and a side section view of the lift platform shown in FIG. 9, with the end and middle lift stops in a retracted position.

FIG. 12 is a side elevation view, partly in section, showing the head gear pivoted to an open position, and showing a lifting mechanism for the lift platform, illustrating the coupling of a lift link carried by the head gear to a lift bar coupled to the lift platform in an initial rest position, after all cans occupy the top row of cans have been dispensed.

FIG. 13 is a side elevation view, partly in section, of the lifting mechanism shown in FIG. 12, but showing how an inactivation lever interrupts coupling between the lift link and lift bar when at least one can occupies the top row of cans, while also allowing dispensing of the can or cans in that row from the apparatus.

FIG. 14 is a front view of the interrupted lifting mechanism shown in FIG. 15, showing dispensing of a can from the apparatus.

FIG. 15 is a side elevation view, partly in section, like that shown in FIG. 12, but now showing the head gear pivoted forward to an intermediate position when the lift link and lift bar are coupled to raise the lift platform within the beverage dispensing chamber and, with it, the columns of cans for dispensing.

FIG. 16 is a side elevation view, partly in section, like that shown in FIG. 15, but now showing the head gear pivoted forward to a closed position when the lift link and lift bar are coupled, thereby completing the lifting of the lift platform and raising a new row of cans into position for dispensing.

FIG. 17 is a side elevation view, partly in section, like that shown in FIG. 16, but now showing the head gear pivoted backward to an open condition, allowing one or more cans in the top row to be withdrawn for consumption, and additional rows of cans present in the dispensing chamber.

FIG. 18 is a side elevation view, partly in section, like that shown in FIG. 17, but showing how an inactivation link lifts the inactivation lever to interrupt coupling between the lift link and lift bar after all cans have been removed from the beverage dispensing chamber, signaling the need to replenish the beverage dispensing chamber.

FIG. 19 is a side elevation view, partly in section, like that shown in FIG. 18, but showing the head gear pivoted forward to a closed position when coupling between the lift link and lift bar has been interrupted by the inactivation link, thereby interrupting further lifting of the lift platform when all cans have been removed from the beverage dispensing chamber.

FIGS. 20 to 25 are interior perspective views of the lift platform showing its interaction with stationary and movable ramps within the beverage dispensing chamber, illustration how the lifting mechanism elevates the lift platform one level of cans at a time for dispensing.

### DESCRIPTION OF THE PREFERRED EMBODIMENTS

Although the disclosure hereof is detailed and exact to enable those skilled in the art to practice the invention, the physical embodiments herein disclosed merely exemplify the invention, which may be embodied in other specific structure. While the preferred embodiment has been described, the details may be changed without departing from the invention.

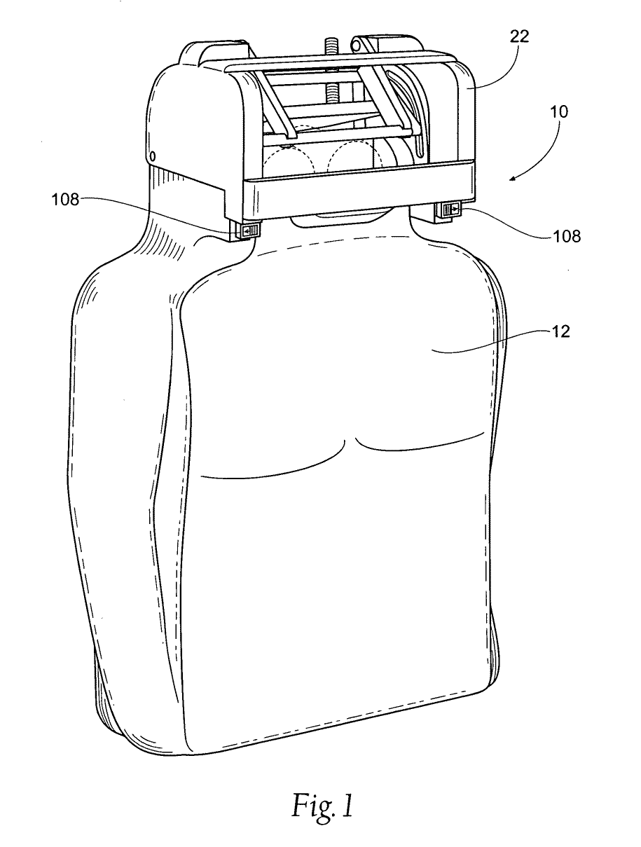

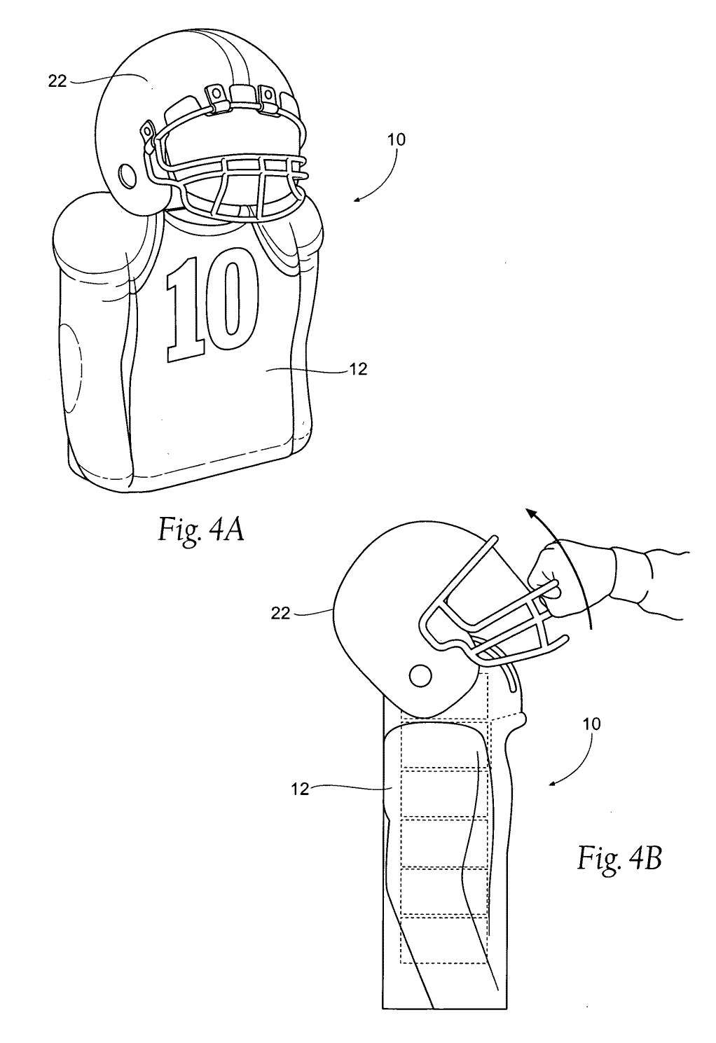

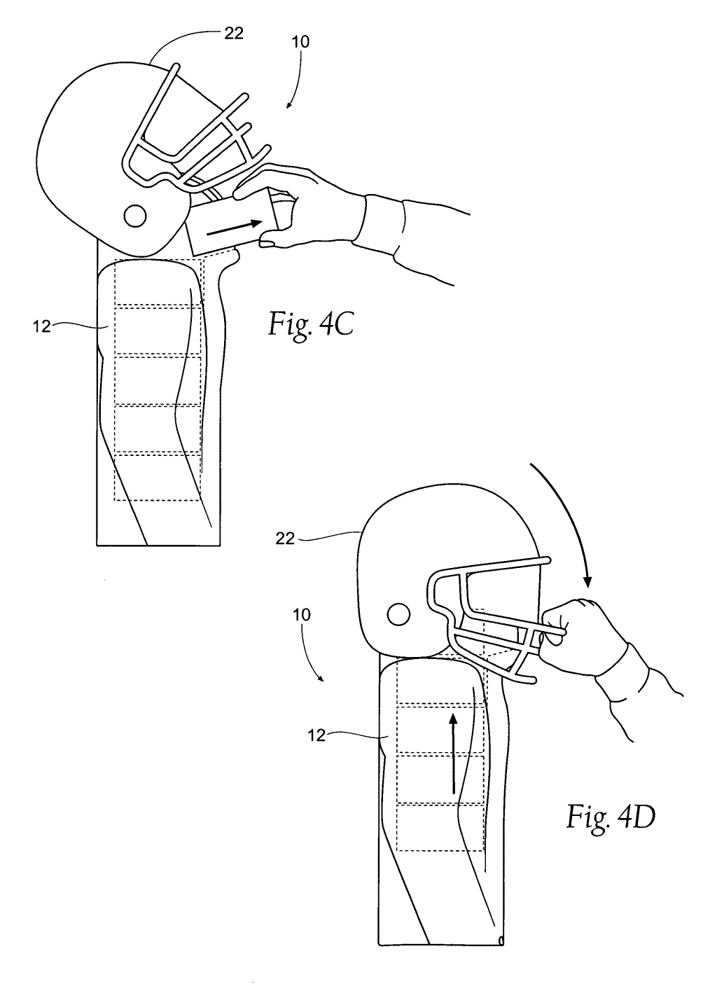

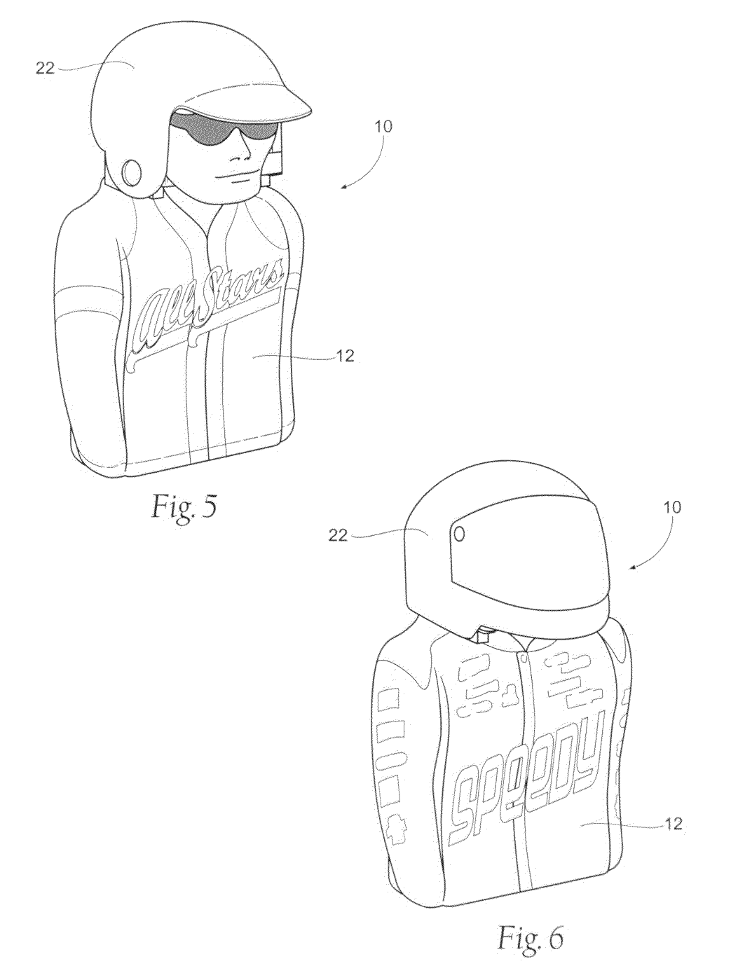

An apparatus 10 for dispensing cans of beverages (shown as cylinders in phantom lines in the drawings) is shown in FIG. 1. The apparatus 10 includes a frame 12 that is sized and configured to emulate a human torso from the waist up, including a head, shoulders, arms, and chest. In illustrative embodiments, the frame 12 is shaped and includes an ornamental skin to emulate a waist-up torso of a sports figure, with corresponding head gear 22; for example, a football player (FIG. 4A) with shoulder pads, numbered or lettered jersey, and a football helmet with face mask; a baseball player with numbered or lettered shirt, and a batting helmet with visor (FIG. 5); or a race car driver with numbered or lettered racing suit, and protective helmet with face shield (FIG. 6). Other figures can be emulated, as desired.

FIG. 1 shows the basic torso frame 12 before ornamentation. It should be appreciated that all or a portion of the frame 12 can be formed from metal, plastic, or metal components, and combinations thereof. The frame 12 can be molded or assembled in parts, or combinations thereof. Desirably, the frame 12 is sized and configured to be lightweight and easily transportable.

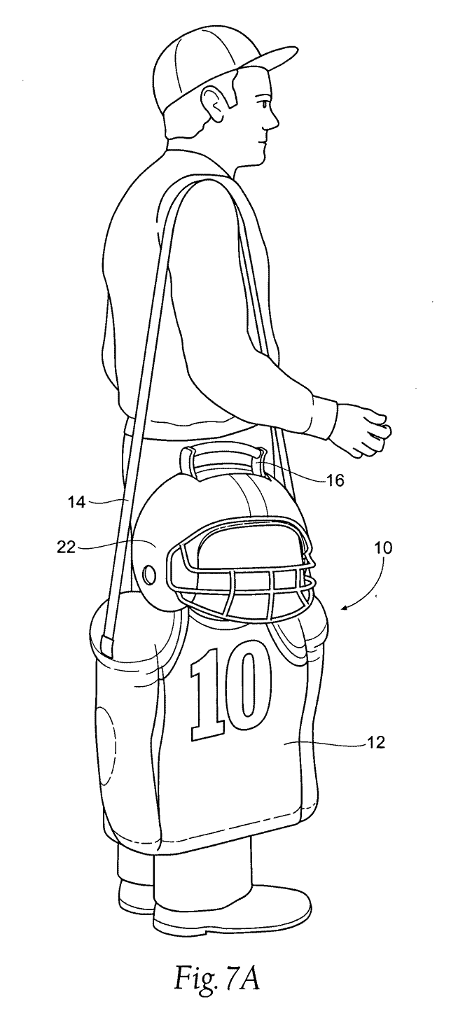

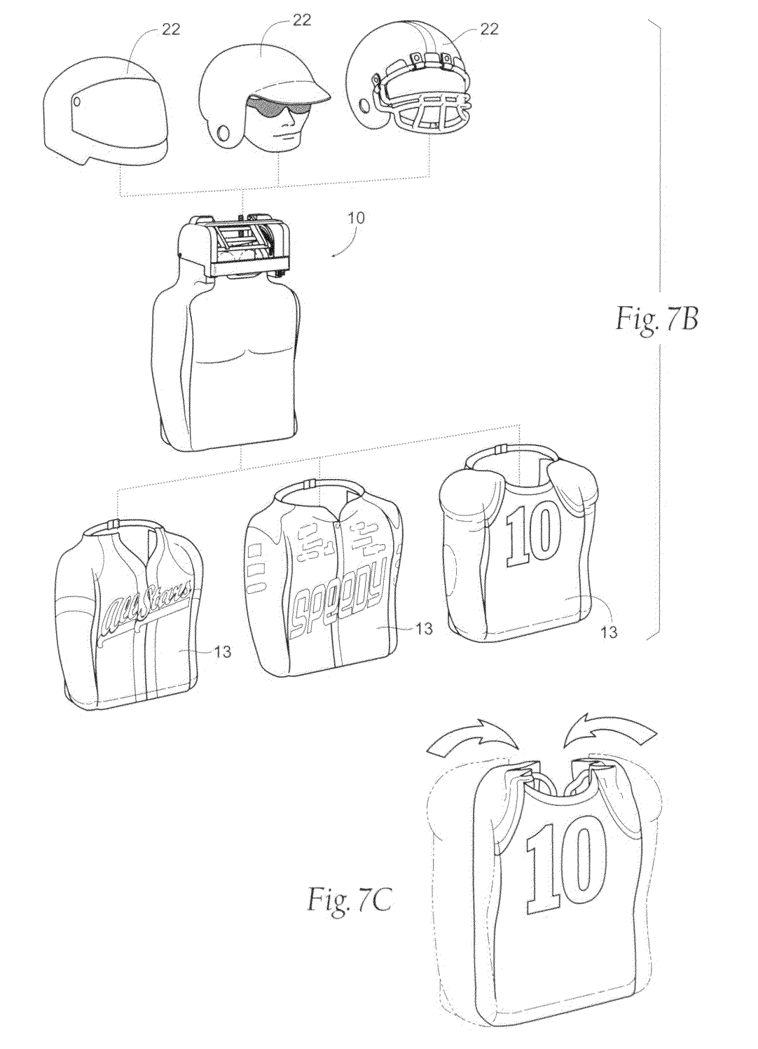

As FIG. 7A shows, the frame 12 is dimensioned to approximate the life-size torso of a human adult. The frame 12 has a base for resting in a flat surface, e.g., on the ground, tabletop, or tailgate of a vehicle.
As FIG. 7A also shows, the frame 12 can include a shoulder strap accessory 14, so that it can be conveniently transported like a shoulder bag. Alternatively, or in combination, as FIG. 7A also shows, the head gear 22 can include a carrying handle 16 for handheld transport.

As FIG. 7B shows, apparatus 10 can be modular in nature, comprising a generic torso frame 12 that can be outfitted as desired with different removable, interchangeable head gear 22 and different removable, interchangeable ornamental skins 13 to provide a variety of different sport motifs. As FIG. 7C shows, the ornamental skins 13 can be configured to be folded for shipment and storage and unfolded to be fitted over the torso frame 12 at time of use. The ornamental skins 13 can be made of a washable material for cleaning between uses.

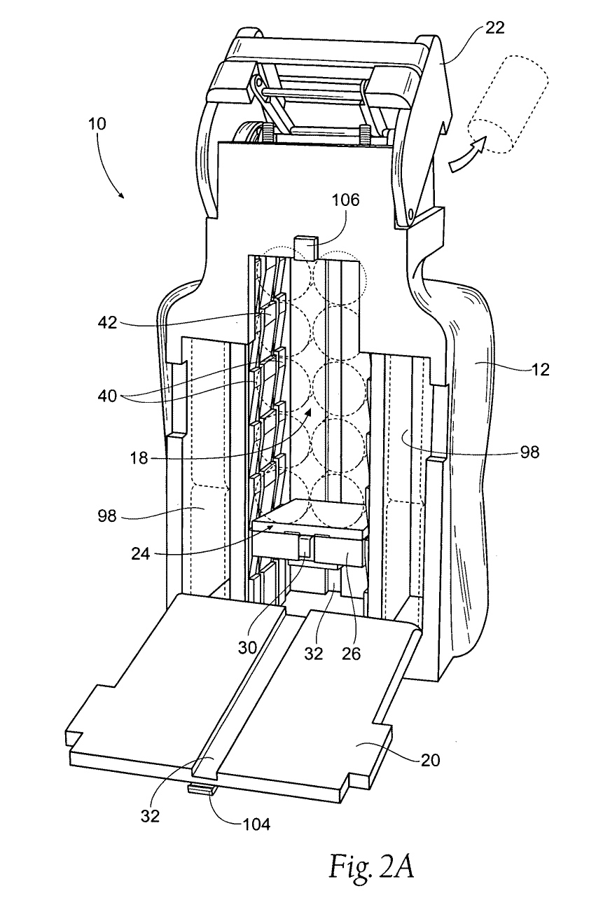

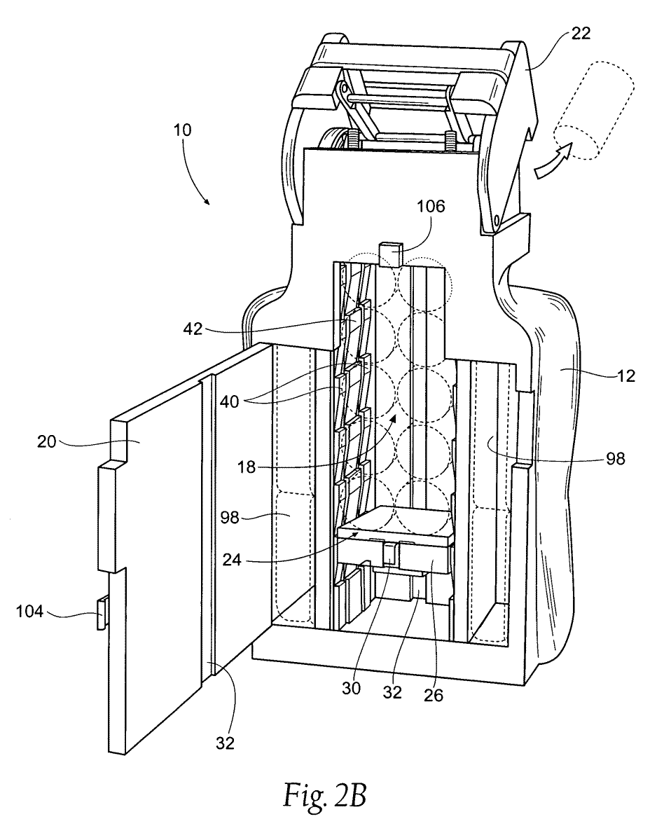

The frame 12 houses a beverage dispensing chamber 18 (see FIGS. 2A and 2B). Desirably, the beverage dispensing chamber 18 is insulated and includes pockets 98 for the insertion of ice packs to chill the beverages.

The frame 12 desirably includes a back panel 20 that can be hinged at the bottom to be dropped open (as FIG. 2A shows) or hinged at the side be swung open (as FIG. 2B shows) to gain access to the beverage dispensing chamber 18 to replenish the supply of beverages and ice packs. In either arrangement, a back panel latch 104 releasably engages a back panel latch plate 106 to maintain the back panel 20 closed. Of course, the frame 12 can be sized and configured to gain access to the beverage dispensing chamber 18 in other ways.

The beverage dispensing chamber 18 is sized and configured to hold a supply of conventionally sized beverage cans for dispensing on demand. In FIGS. 2A and 2B, the cans are of the twelve fluid ounce variety. Of course, the frame 12 and dispensing chamber 18 can be sized and configured to accommodate smaller volume cans or larger volume cans, or even other types of beverage containers.

In the illustrative embodiment shown in FIGS. 2A and 2B, the dispensing chamber 18 is sized and configured to hold twelve, twelve ounce beverage cans. With the back panel 20 dropped and opened, the beverage cans can be manually stacked by the user into two side-by-side dispensing columns, each holding six, vertically stacked cans, presenting rows of two cans each for dispensing.

Of course, other interior stacking arrangements can be envisioned, and the size and configuration of the frame 12 can be modified to accommodate them.

In use, as will be explained in greater detail later, when the head gear 22 is in a normal, forward facing, closed condition, as FIG. 4A shows, the dispensing chamber 18 is closed and access to the beverage cans is blocked. The row of two beverage cans on the top of the dispensing columns are exposed by pivoting the head gear 22 of the sports figure backward, as shown in 4B. To gain access to the beverage cans, the operator lifts up on the head gear 22 (in FIG. 4B, by lifting up on the face guard, or in other embodiments, by lifting up on the base ball cap visor, or lifting up on the chin of the racing helmet). The head gear 22 pivots about a rear pivot point, pivoting backward, as FIG. 4B shows. With the head gear 22 pivoted backward, the top row of beverage cans is accessible. The operator can reach into the dispensing chamber 18 and withdraw one or both beverage cans from the top row, as FIG. 4C shows. A releasable head gear latch 108 (see FIG. 1) normally locks the head gear 22 in forward facing, closed condition. Releasing the latch 108, as shown by arrows in FIG. 1, enables the head gear 22 to be lifted.

FIGS. 2A and 2B show, in a rear view, the condition of the apparatus 10 when the head gear 22 has been pivoted back (as FIG. 4C shows in side view) for the removal of one or both beverage cans from the top row of the dispensing columns.

As FIG. 4D shows, after withdrawing one or both cans from the top row of the dispensing chamber 18, the user can push down on the head gear 22. The head gear 22 pivots about the rear pivot point, pivoting back to the forward facing, closed condition, as FIG. 4D shows. With the head gear 22 pivoted forward, access to the dispensing chamber 18 is again blocked.

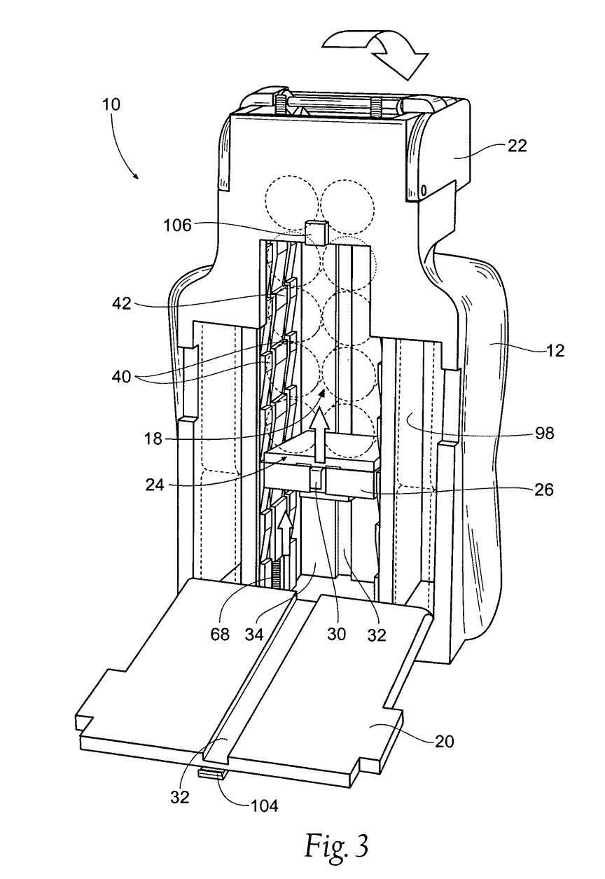

As will be described in greater detail later, the apparatus 10 includes a mechanical lifting mechanism 24 residing in the dispensing chamber 18 that is coupled to the head gear 22. This is generally shown in FIGS. 2A/B and 3. When both beverage cans occupying the top row of the dispensing columns have been removed, the lifting mechanism 24 is actuated by moving the head gear 22 from the backward pivoted, open condition (shown in FIGS. 2A/B and 4C) to the forward pivoted closed condition (shown in FIGS. 3 and 4D). When actuated, the lifting mechanism 24 advances the dispensing columns upward by one row, as a comparison of FIG. 2A/B and FIG. 3 shows. The lifting mechanism 24 does not rely upon the application of spring tension to lift the beverage containers, but rather applies an upward lifting force only upon demand, e.g., by closing the head gear 22. As a result, the beverage cans residing in the dispensing chamber 18 are normally not under tension, but normally rest passively in the dispensing chamber 18. A lifting force is applied only when required.

To recap, after withdrawal of both beverage cans from their row through the pivoted open head gear 22 (shown in FIGS. 2A/B and 4B and 4C)), return of the head gear 22 to the pivoted closed condition (shown in FIGS. 3 and 4D) lifts the next row of cans upward for access by the operator. As will be described in greater detail later, operation of the lifting mechanism requires that both cans in a given row be withdrawn before the next row of cans can be lifted for access. The new row of beverage cans, when lifted, is exposed for dispensing by again pivoting the head gear 22 of the selected sports figure backward. After withdrawal of both beverage cans from their row through the pivoted open head gear 22, subsequent return of the head gear 22 to the pivoted closed condition lifts the next row of cans upward for access by the operator, and so on until the last row of cans is withdrawn. As will also be described in greater detail later, the lifting mechanism 24 is automatically deactivated as the last row of cans is lifted for dispensing. The dispensing chamber 18 then needs to be replenished by dropping open the back panel 20 and manually restacking the two dispensing columns of beverage cans on the lifting mechanism 24.

The mechanical and structural features of the apparatus 10 as just generally described can be implemented in variously ways. An illustrative embodiment will be described.

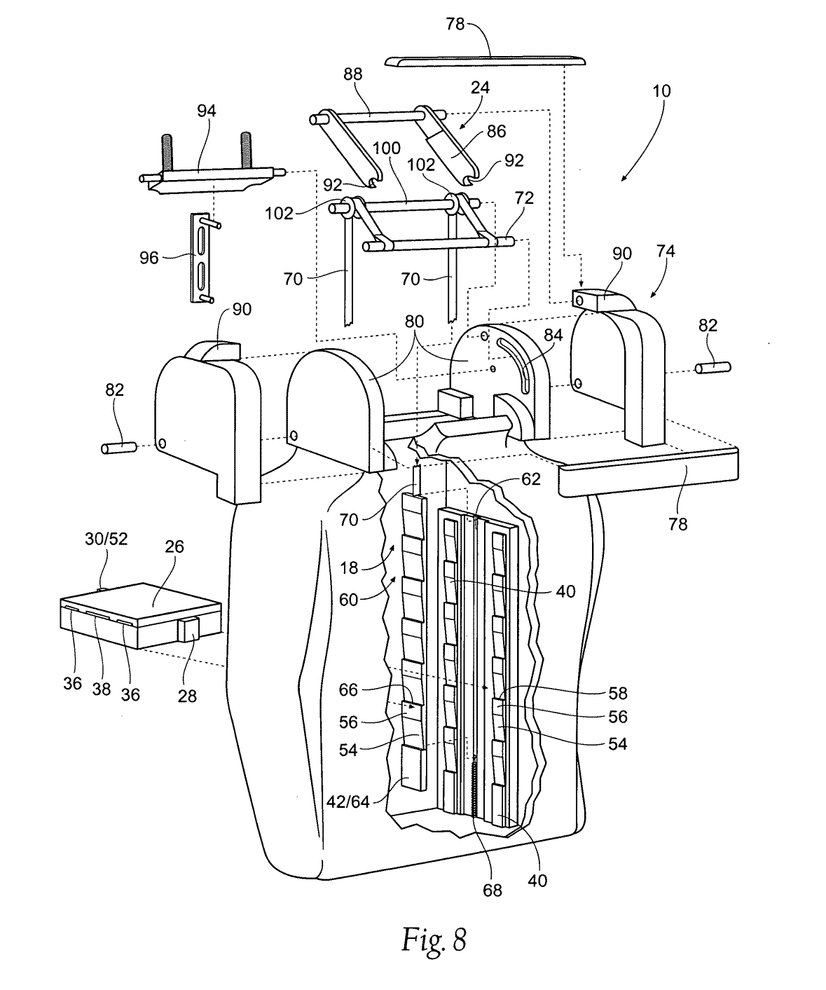

FIG. 8 shows illustrative mechanical and structural components of the apparatus 10 in an exploded view, and the relative position of these components can be further understood by reference to other figures, as follows. It should be appreciated that other mechanical and structural components having equivalent functions can be substituted for those shown without changing the form, function, or fit of the apparatus 10.

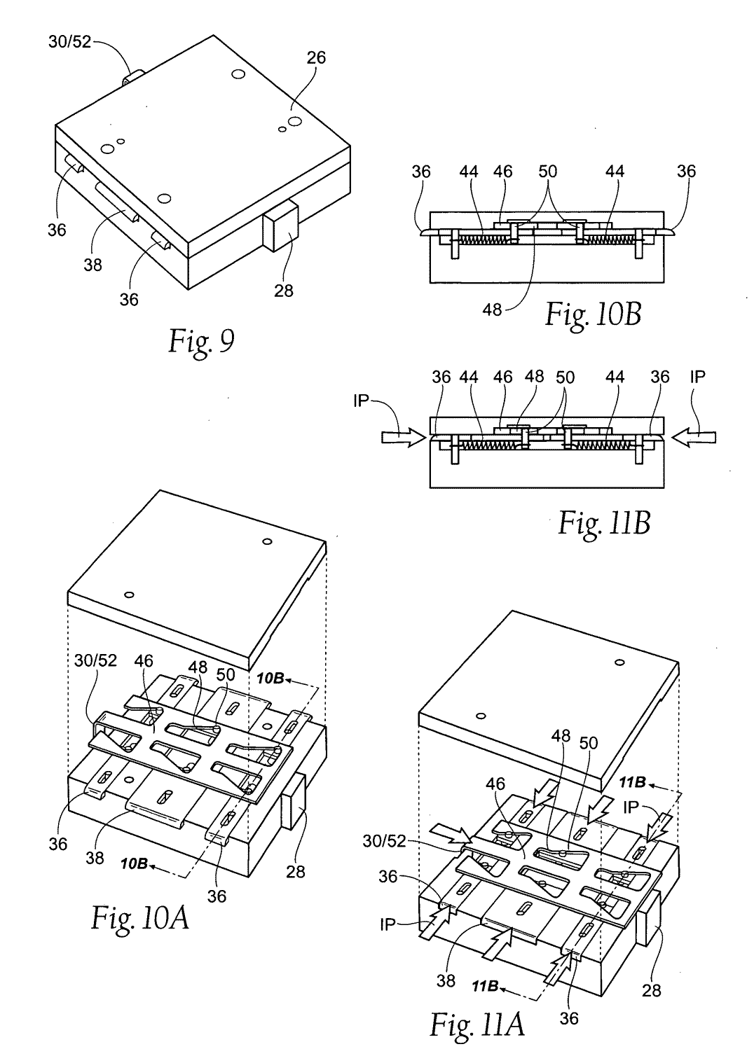

The lifting mechanism 24 includes a lift platform 26 (see FIG. 8) that resides in the beverage dispensing chamber 18, as FIGS. 2A/B and 3 also show. Further details of the lift platform 26 are also shown in FIGS. 9; 10 A/B; and 11 A/B.

As FIG. 9 shows, the lift platform 26 includes front and rear track runners 28 and 30. As FIGS. 2A/B and 3 show, the track runners 28 and 30 ride in oppositely facing, vertical tracks 32 formed in a front wall 34 of the frame 12 and the back panel 20. The lift platform 26 therefore moves like an elevator in the beverage dispensing chamber 18, as FIGS. 4C and 4D show.

The cans of the bottom row of the dispensing columns rest on and are supported by the lift platform 26 (see FIGS. 2A/B and 3). The remaining cans are stacked in the dispensing columns above and are likewise supported by the lift platform 26. The operator loads the cans in the dispensing columns with the platform positioned in its lowermost position, shown in FIGS. 2A/B.

The lift platform 26 (see FIGS. 9, 10A/B, and 11A/B) includes spring biased lift stops 36 and 38 along each lateral side of the lift platform 26. In the representative embodiment, there are three lift stops on each lateral side of the lift platform 26. On each lateral side, there are two end lift stops 36 and an intermediate or middle lift stop 38 in between the end lift stops 36. As will be described in greater detail, the end lift stops 36 interact with an array of stationary ramps 40 within the dispensing chamber 18, while the middle lift stops 38 interact with an array of movable ramps 42 within the dispensing chamber.

Each lift stop 36 and 38 is individually biased by a spring 44 within the lift platform 26 (see FIGS. 10B and 11B) toward a laterally extended position, projecting beyond the lateral side of the lift platform 26 (shown in FIGS. 9, 10A, and 10B). Each lift stop 36 and 38 can be depressed in response to external inward lateral pressure (shown by the arrows IP in FIGS. 11A and 11B), to move the respective lift stop 36 and 38 from the laterally extended position to a laterally retracted position, generally flush with an edge of the lift platform 26, which is shown in FIGS. 11A and 11B. Due to the action of the individual biasing springs 44, upon removal of the external inward pressure IP upon a given lift stop 36 and 38, the given lift stop 36 and 38 will spring back to its normally laterally extending position shown in FIGS. 10A and 10B.

To facilitate placement and removal of the lift platform 26 in the dispensing chamber 18, the lift platform 26 includes a manually actuated cam plate 46, which moves all the lift stops 36 and 38 in unison into their laterally retracted position (see FIGS. 10 A/B and 11 A/B). The cam plate 46 includes an array of tapering cam surfaces 48 that engage cam followers 50 on the individual lift stops 36 and 38. The cam plate 46 manually slides within the lift platform 26 by force applied to an external flange 52 in a direction transverse the path of movement of the lift stops 36 and 38. Sliding the cam plate 46 in this direction moves the cam surfaces 48 in unison relative to all the cam followers 50, to draw the lift stops 36 and 38 in unison into their laterally retracted position (as FIG. 11A shows). This facilitates placement of the lift platform into the dispensing chamber 18, as will be demonstrated later. When force is removed from the flange 52, the spring biased lift stops 36 and 38 will automatically return in unison to their laterally extended positions, sliding the cam plate 46 back to its original condition.

In the illustrated embodiment, the exterior flange 52 that operates the cam plate 46 also serves as the rear runner 30 of the lift platform 26, as previously described.

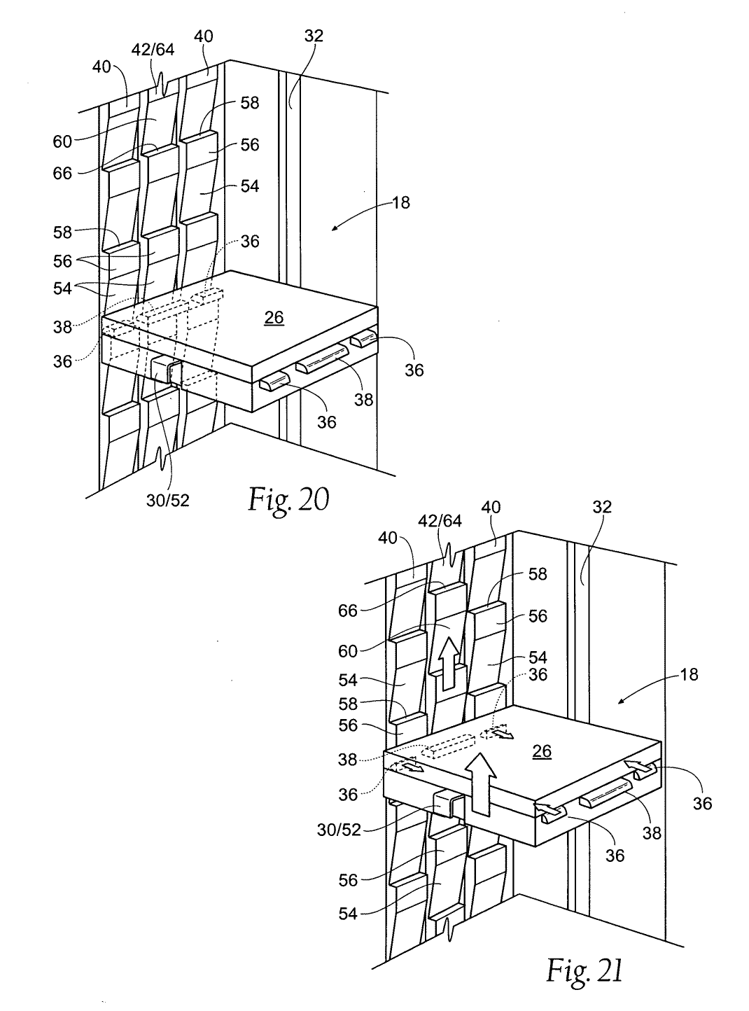

The lift platform 26 ascends vertically upward in the dispensing chamber 18 stepwise like an elevator along a repeating symmetrical array of stationary ramps 40 (see FIGS. 8 and 20), which are laterally spaced apart on opposite sides of the dispensing chamber 18 (see FIGS. 2A/B and 3), as well as vertically spaced apart along each side of the dispensing chamber 18. These ramps 40 interact in a predefined manner with the end lift stops 36 on the lift platform 26 (as shown in FIGS. 20 to 23), mechanically providing a deliberate, stepwise advancement of the lift platform 26 from the bottom to the top of the dispensing chamber, one ramp 40 at a time, to make available for dispensing one row of cans at a time, as is generally shown in FIGS. 4B to 4D). No constant tension spring force is required to lift the platform 26.

More particularly, the stationary ramps 40 are arranged on oppositely facing sides of the beverage dispensing chamber 18, along the path of vertical ascension of the lift platform 26. As shown in FIG. 20, each stationary ramp 40, when viewed vertically from bottom to top in the beverage dispensing chamber 18, tapers progressively outward toward the interior of the beverage dispensing chamber 18 from a lowest surface elevation 54 to a highest surface elevation 56. As Fig. shows, the highest surface elevation 56 of one stationary ramp abuts immediately against the lowest surface elevation 54 of the next successive stationary ramp above it, forming at each junction a ledge 58.

When the back panel 20 is open, as FIGS. 2A/B show, the lift platform 26 can be placed into the beverage dispensing chamber 18 with the front and rear runners 28 and 30 aligned with their respective tracks 32. The spaced apart end lift stops 36 on opposite lateral sides of the lift platform 26 are sized and configured to ride against the stationary ramps 40 that are spaced apart on opposite lateral sides of the dispensing chamber 18. This is also shown in FIG. 20.

Operation of the cam plate 46 as just described serves to temporarily retract all the lift stops 36 and 38 in unison, so that the lift platform 26 can be easily inserted between the array of stationary ramps 40 without interference between the rest stops 36 and 38 and the stationary ramps 40. Release of the cam plate 46 mechanism causes the end lift stops 36 to engage the stationary ramps 40 for use. The lift platform 26 is installed with the lift stops 36 resting on the bottommost ledges 58 (shown in FIGS. 2A/B), at the junction of the highest surface elevation 56 of the lowest array of stationary ramps 40 and the lowest surface elevation 54 of the next higher stationary ramps 40.

A lifting force is applied to the lift platform 26, as will be described in greater detail later. The lift platform 26 ascends in the beverage dispensing chamber 18 sequentially along each row of stationary ramps. The ascending lift platform 26 lifts the dispensing columns of cans with it.

The array of spaced apart stationary ramps 40 are sized and configured in the vertical dimension so that the distance between stationary ledges 58 at each level of the stationary ramps 40 corresponds with the separation of each row of cans in the dispensing columns. Thus, the dispensing columns are advanced by the lift platform 26 stepwise along the array of stationary ramps 40 one row of cans at a time.

As the lift platform 26 ascends along a given array of stationary ramps 40 from one level to the next, the end lift stops 36 retract as increasing elevations of the stationary ramps 40 are encountered (see FIGS. 20, 21, and 22), until the end lift stops 36 encounter a junction at the next vertically higher array of stationary ramps 40 (as shown in FIG. 23). Now encountering a lowest surface elevation 54, the spring biased end lift stops 36 will return immediately toward their laterally extended positions, as shown in FIG. 23. The end lift stops 36 rest on the ledges 58 at this junction, to resist downward retreat or slippage of the lift platform 26 and its contents. However, further ascension can resume in response to a resumption of the lifting force.

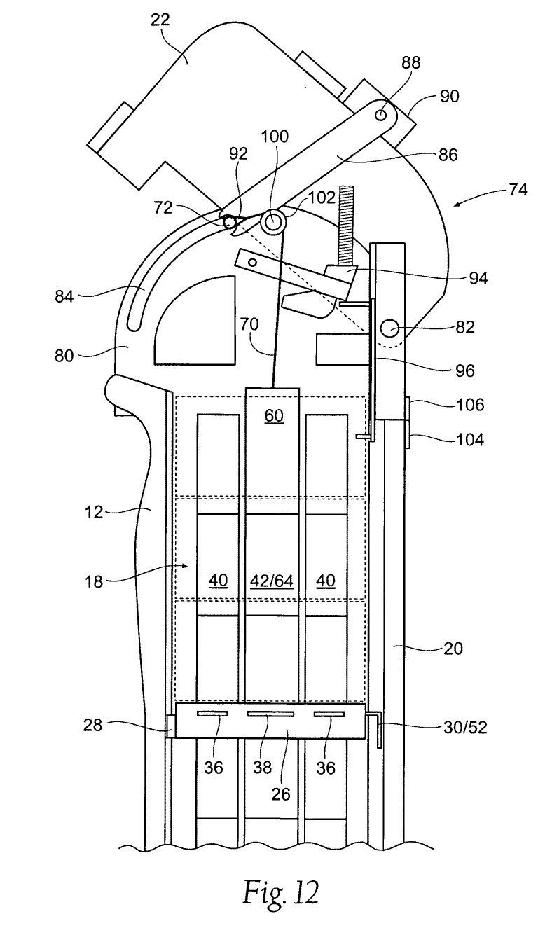

The lifting force is applied to the lift platform 26 by a symmetric pair of movable side lifters 60 that reside in the dispensing chamber 18, as shown in FIGS. 2, 8, and 22. The movable side lifters 60 are coupled to the head gear 22, so that pushing the head gear 22 down from a rearward pivoted position to a forward facing condition actuates the side lifters 60 to lift the lift platform 26 one level along the stationary ramps 40. This is illustrated in FIGS. 12; 15; and 16.

The movable side lifters 60 are located on opposite lateral sides of the beverage dispensing chamber 18 between the spaced apart arrays of stationary ramps 40 (as also shown in FIG. 20). The movable side lifters 60 slide within tracks 62 in the side walls of the frame 12 (see FIG. 8) between the spaced apart array of stationary ramps 40.

As best shown in FIG. 20, each movable side lifter 60 includes a vertical array of lifting ramps 64 having generally the same vertical dimensions and tapering elevations as the stationary ramps 40 that lay alongside. The middle end stops 38 of the lift platform 26 engage the lifting ramps 64. The lifting ramps 64 progress from bottom to top from a lowest surface elevation 54 to a highest surface elevation 56 corresponding to these elevations 54 and 56 on the stationary ramps 40. Ledges 66 are therefore also formed on the movable side lifters 60 at intervals corresponding to the separation of each row of cans in the dispensing columns, and the ledges 66 of the movable side lifters 60 coincide with the ledges 58 of the stationary ramps 40. The lift platform 26 is thus kept level as it is lifted by the movable side lifters 60 stepwise to the ascending levels of the stationary ramps 40.

Each movable side lifter 60 is coupled at its bottom edge to the frame 12 by an expandable spring 68, as can be seen in FIGS. 3 and 8. The spring 68 expands in response to ascension of the side lifters 60 in response to a lifting force that is applied by operation of the head gear 22, as will be explained later. In the absence of an applied lifting force, the springs 68 bias the side lifters 60 toward a normally fully descended position in the dispensing chamber, shown in FIG. 2. In this position (see also FIG. 20), the end lift stops 36 rest in their extending position on the ledges 58 of the stationary ramps 40, and the middle lift stops 38 rest in the extended position on the ledges 66 of the movable side lifters 60.

Vertical lifting members 70 are coupled to the upper edges of the side lifters 60 (sees FIGS. 8 and 12). In a representative embodiment, the lifting members 70 comprise flexible, non-elastic metal, plastic, or fabric strips or cables. The opposite ends of the lifting members 70 are, in turn, coupled to a lift bar 72 supported for movement in the head gear region of the apparatus 10 (as FIGS. 8 and 12 also show). Tension rollers 102 (see FIG. 8) that rotate about a tension bar 100 direct and keep the lifting members 70 in tension between the lift bar 72 and the side lifters 60.

As shown in FIG. 8, the torso frame 12 includes a head gear frame 74, which provides the structure for the head gear 22. In the illustrated embodiment, the structure is assembled from side risers 76 coupled by spanning braces 78, top and front. It should be realized that the head gear frame 74 could comprise an integrated molded structure.

The torso frame 12 includes spaced apart mounts 80 for the head gear frame 74, rising from the “shoulders” of the torso frame 12 (see FIG. 8). The rear of the head gear frame 74 is pivotally connected, e.g., by pivot pins 82 or the like, to the mounts 80. This permits the forward and backward pivotal movement of the head gear 22, as described above.

The lift bar 72 moves within channels 84 in the mounts (see FIGS. 8 and 12). The head gear 22 is selectively coupled by a lift link 86 to the lift bar 72. The lift link 86 is appended to a lift link shaft 88, which is pivotally coupled to journals 90 on opposite side of the head gear frame 74. The lift link 86 pivots about the axis of the lift link shaft 88.

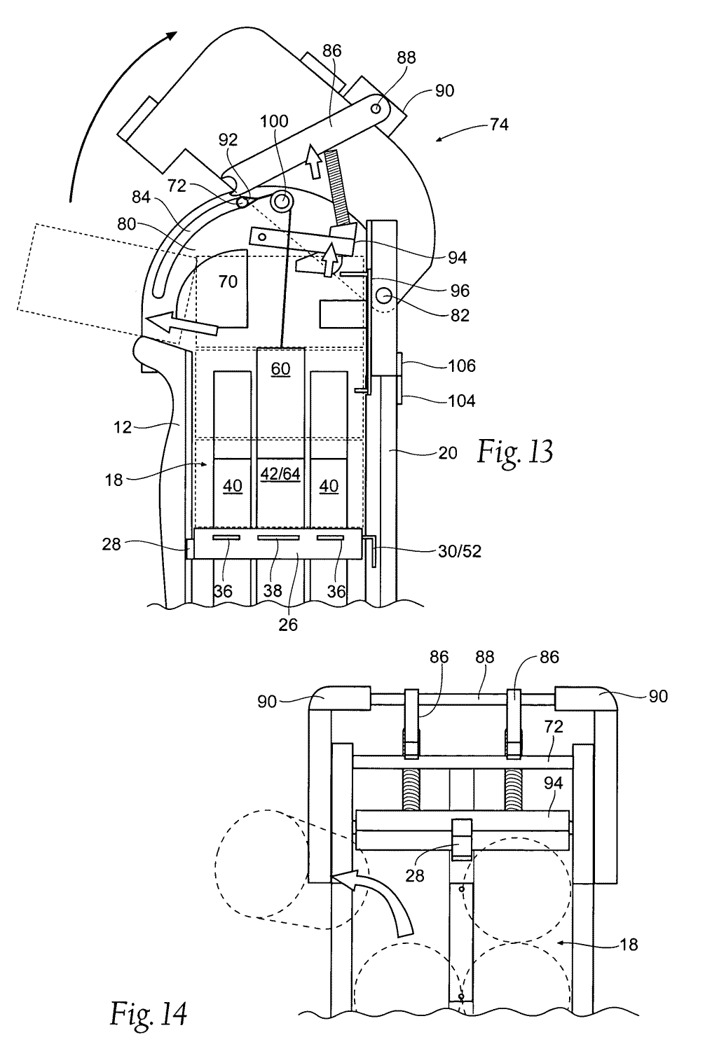

As shown in FIG. 12, the lift link 86 includes a notched contact region 92 that is sized and configured to pivot into engagement with the lift bar 72 when the head gear 22 is pivoted in its backward open condition. This engagement is permitted, however, only when no cans are present in the top row of the dispensing columns, as FIG. 12 shows. When one or more cans are present in the top row of the dispensing columns (as shown in FIGS. 13 and 14), the can(s) contact an inactivation lever 94, pivotally attached to the mounts 80 of the head gear frame 74. The contact between the can(s) and the inactivation lever 94 pivots the inactivation lever 94 into contact with the lift link 86. This contact pivots the lift link 86 upward, and the notched contact region 92 no longer aligns with the lift link 86. Moving the head gear 22 to its forward facing position does not engage the lift link 86 and the lift bar 72. Therefore, no lifting of the lift platform 26 occurs.

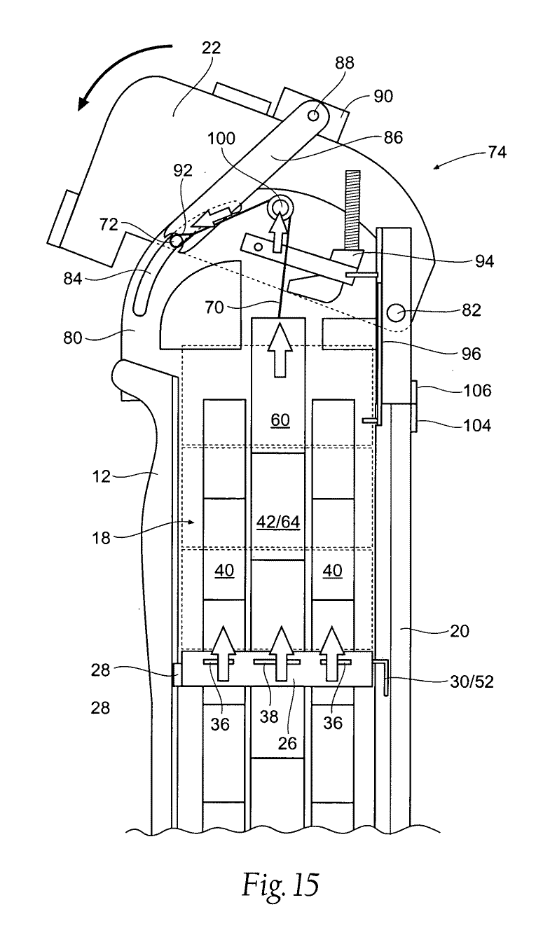

However, when no cans are present in the top row, and the head gear 22 is pivoted backward, the inactivation lever 94 does not contact the lift link 86 (as FIG. 12 shows). The notched contact region 92 of the lift link 86 aligns with and contacts the lift bar 72 (as FIG. 12 shows). Subsequent movement of the head gear 22 toward its forward facing position (as FIG. 15 shows) advances the lift bar 72 forward along the channels 84 of the mounts 80. This, in turn, transmits a lifting force through the lift members 70 to the movable side lifters 60, which ascend in unison within the dispensing chamber 18.

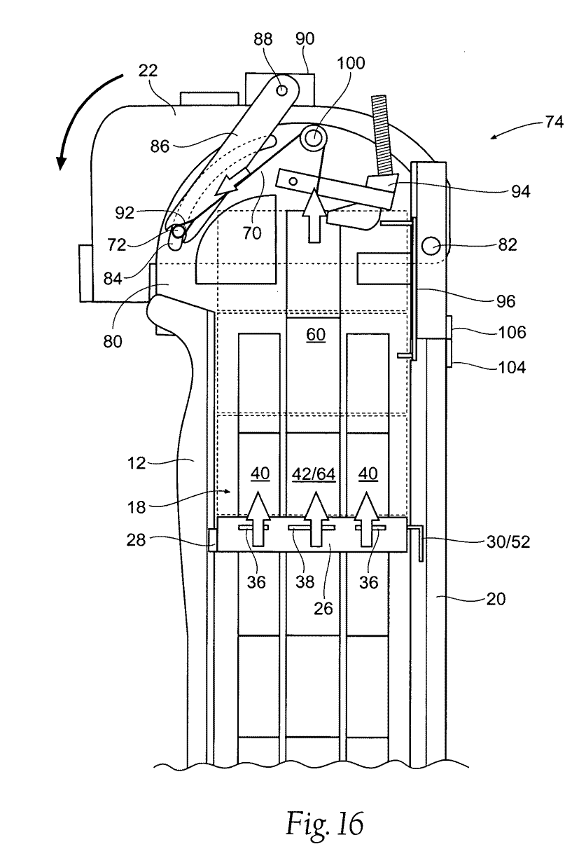

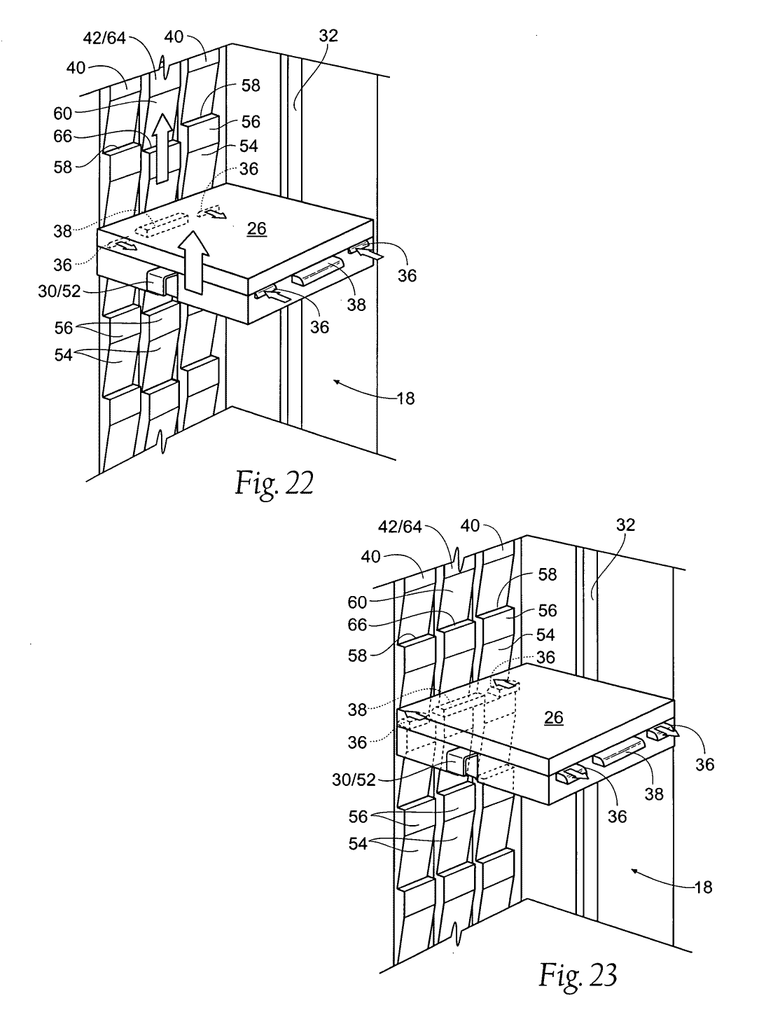

As FIG. 15 further shows, since the middle lift stops 38 of the lift platform 26 rests against the ledges 66 of the movable side lifters 60, lifting the movable side lifters 60 will in turn lift the lift platform 26. As shown in FIGS. 21 and 22, the end lift stops 36 of the lift platform 26 retract to accommodate the ascension of the lift platform 26 along the stationary ramps 40, as already described, until the end lift stops 36 encounter a junction with the next vertically higher array of stationary ramps 40, as shown in FIG. 23. This encounter generally coincides with the closing of the head gear 22, as FIG. 16 shows.

Encountering now a lowest surface elevation 54 at the junction, the spring biased end lift stops 36 return toward their laterally extended positions and come to rest on the ledges 58 on the next level of stationary ramps 40, as FIG. 23 shows). The end rest stops 36 thereafter resist retrograde movement of the lift platform 26 downward. The next row of cans has been lifted into a stabile and secure condition for dispensing, as FIG. 16 shows.

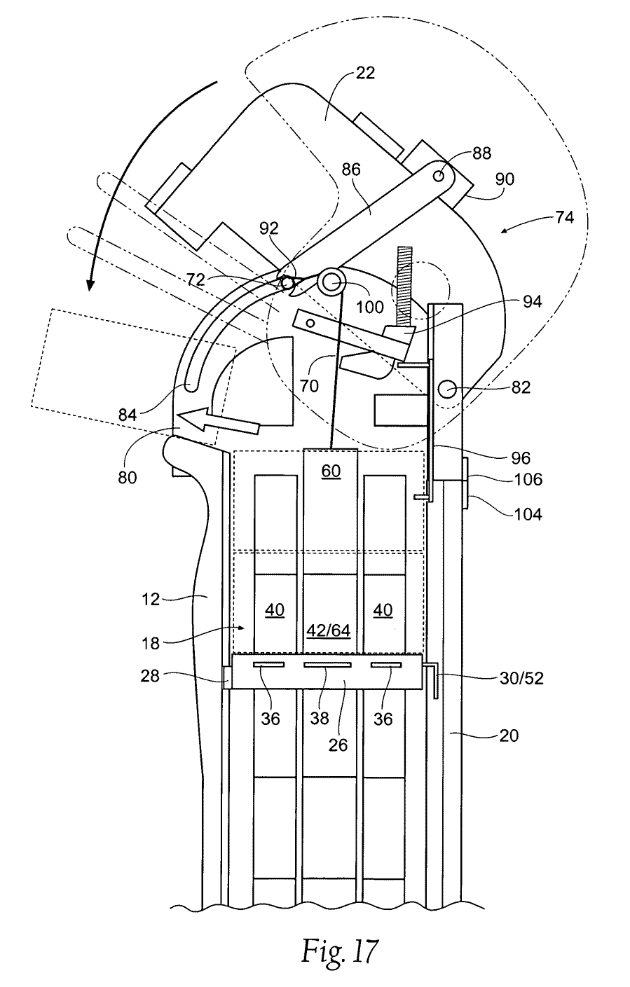

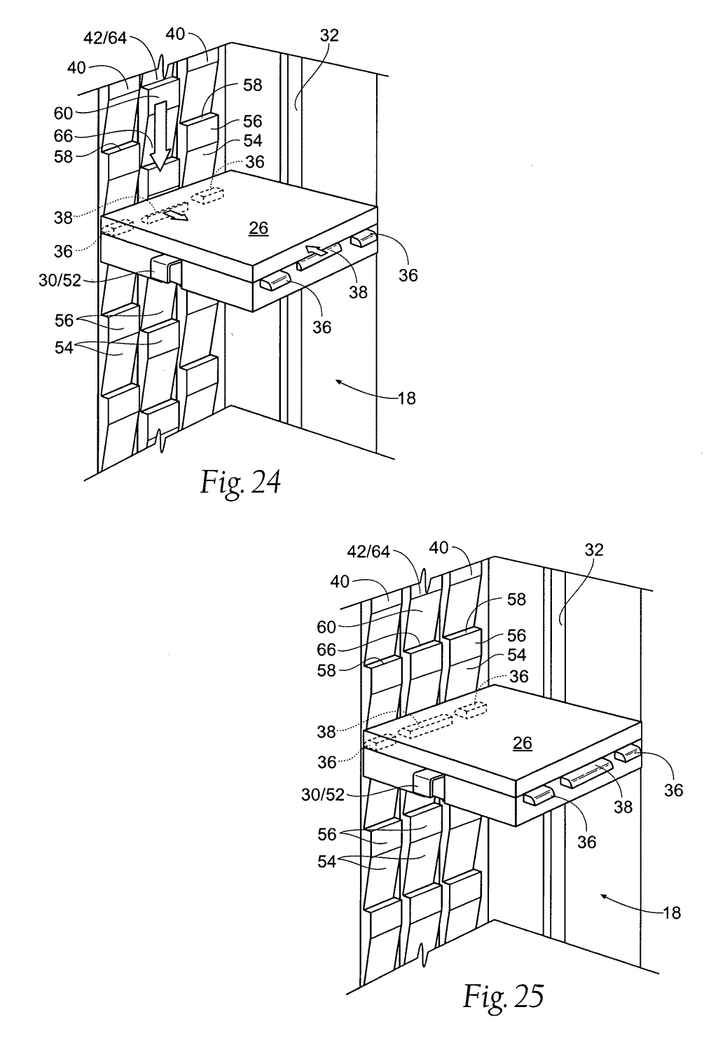

When the head gear 22 is opened to gain access to the row of cans (as FIG. 17 shows), the movable side lifters 60 will, in response to the contraction of the springs 68 coupled to their bottom edges, descend downward relative to the lift platform 26 and the stationary ramps 40, as FIG. 24 also shows. The downward movement of the side lifters 60 in response to the springs 68 will move the lift bar 72 back to its initial position at the back of the channels 84 in the mounts 80 (as FIG. 17 shows). The lift bar 72 is now repositioned for renewed alignment with the lift link 86.

As shown in FIGS. 24 and 25, as the movable side lifters 60 descend downward relative to the lift platform 26 (which remains stationary because of the engagement between the end lift stops 36 and the ledges 58 of the stationary ramps 40), the middle lift stops 38 will yield and retract as increasing elevations of the movable lifting ramps 64 of the descending side lifters 60 are encountered, until the middle lift stops 38 encounter a junction with the next vertically higher array of lifting ramps 64 on the movable side lifters 60. Encountering a lowest surface elevation 54 at this junction, the spring biased middle lift stops 38 will spring back to their laterally extended positions, at rest on the ledges 66. This is shown in FIG. 25.

Resting on the ledges 66 of the next vertically higher array of lifting ramps 64, the middle rest stops 38 are in position to carry the lift platform 26 to the next higher level of stationary ramps 40 in response to the application of a new lifting force upon the lifting platform, by repeating the sequence described above.

Thus, the level of the lifting ramps 64 on the movable side lifters 60 in contact with the lift platform 26 is sequentially raised with each lift of the lift platform 26 along the stationary ramps 40, as the lift platform 26 ascends sequentially up the stationary ramps 40 and the movable side lifters 60, until all rows of dispensing columns are eventually raised for access and dispensing through the open head gear 22.

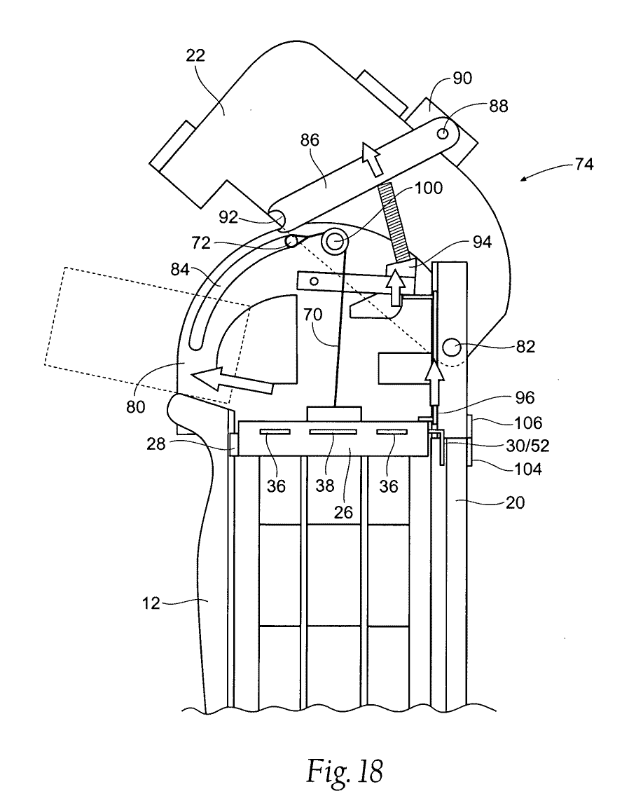

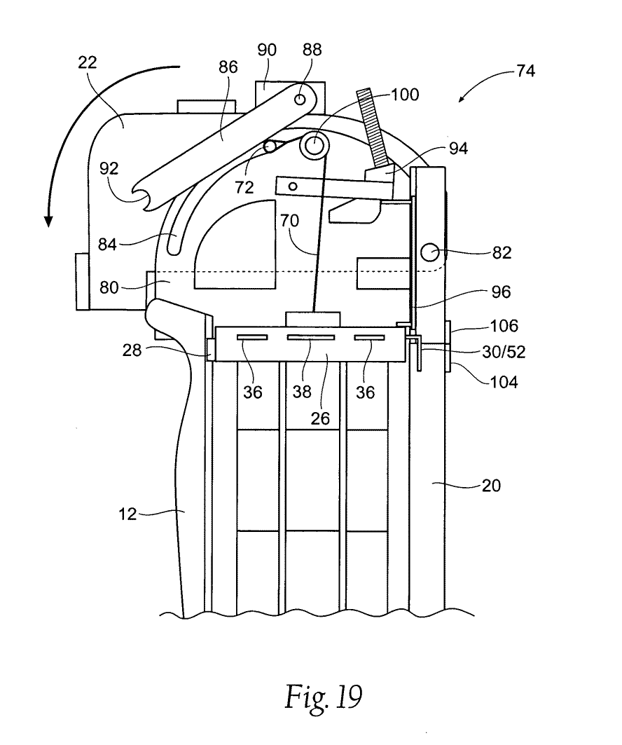

As shown in FIG. 18, when the lift platform 26 has ascended to its highest position within the dispensing chamber 18, the lift platform 26 contacts an inactivating link 96 that is carried for vertical movement on one of the mounts 80. The inactivating link 96 contacts the inactivation lever 94 in the same manner that the presence of a can does when occupying a row of the dispensing column. The inactivation lever 94 in turn pivots the lift link 86 to prevent its engagement with the lift bar 72 (as shown in FIGS. 18 and 19).

The operator needs to replenish the dispensing chamber, as previously described.

The foregoing is considered as illustrative only of the technical features of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A beverage dispensing apparatus comprising
a frame decoratively shaped like a human torso defining a dispensing chamber,
the dispensing chamber being sized and configured to hold a number of beverage containers vertically stacked in rows in the dispensing chamber between an uppermost row and a bottommost row,
a head gear pivotally mounted on the frame for movement between an opened position permitting access to the uppermost row of the beverage containers and a closed position blocking the access, and
a mechanical lifting mechanism coupled to the head gear and being sized and configured to apply a lifting force upon the rows of beverage containers upward within the dispensing chamber in response to pivoting the head gear from the opened position to the closed position.

2. A beverage dispensing apparatus as defined in claim 1
wherein the lifting mechanism includes linkage that deactivates the lifting mechanism until all beverage containers in a given row are dispensed.

3. A beverage dispensing apparatus as defined in claim 1
wherein the lifting mechanism includes linkage that inactivates the lifting mechanism when the bottommost row of beverage containers has been lifted up for access.

4. A beverage dispensing apparatus as defined in claim 1
wherein the lifting mechanism includes tracks in the dispensing chamber and a lift platform that ascends vertically upward on the tracks in the dispensing chamber in response to pivoting the head gear from the opened position to the closed position, and
wherein beverage containers are stacked in rows on the lift platform.

5. A beverage dispensing apparatus as defined in claim 4
wherein the tracks include stationary ramps,
and wherein the lift platform includes spring biased lift stops that engage the stationary ramps to provide stepwise vertical advancement of the lift platform upward in response to pivoting the head gear from the opened position to the closed position.

6. A beverage dispensing apparatus as defined in claim 5
wherein the lift platform includes a cam plate coupled to the spring biased lift stops and being sized and configured to retract the spring biased lift stops so that the lift platform can be removed from and inserted into operative association with the stationary ramps.

7. A beverage dispensing apparatus as defined in claim 4
wherein the lifting mechanism includes side lifters that couple the lift platform to the head gear so that, as the head gear is pivoted from an opened position to a closed position, the side lifters apply a lifting force to the lift platform.

8. A beverage dispensing apparatus as defined in claim 1
further including a decorative skin fitted on the frame.

9. A beverage dispensing apparatus as defined in claim 1
wherein the frame is decoratively shaped as a sports figure.

10. A beverage dispensing apparatus as defined in claim 1
wherein the dispensing chamber is insulated.

11. A beverage dispensing apparatus as defined in claim 1
wherein the dispensing chamber is sized and configured to hold a cooling fluid pack to cool the dispensing chamber.

12. A modular beverage dispensing system comprising
a frame decoratively shaped like a human torso defining a dispensing chamber,
the dispensing chamber being sized and configured to hold a number of beverage containers vertically stacked in rows in the dispensing chamber between an uppermost row and a bottommost row,
a head gear mount pivotally mounted on the frame for movement between an opened position permitting access to the uppermost row of the beverage containers and a closed position blocking the access,
a mechanical lifting mechanism coupled to the head gear mount and being sized and configured to lift the rows of beverage containers upward within the dispensing chamber in response to pivoting the head gear from the opened position to the closed position,
at least two first and second decorative skins, each expressing a different decorative motif, each first and second decorative skins being sized and configured for replaceable fitment on the frame, and
at least two first and second decorative head gear, the first head gear being consistent with the decorative motif of the first decorative skin, the second head gear being consistent with the decorative motif of the second decorative skin, each first and second decorative head gear being sized and configured for replaceable fitment on the head gear mount.

13. A beverage dispensing apparatus comprising
a frame having a top, bottom, and sides defining a dispensing chamber sized and configured to hold a number of beverage containers vertically stacked in rows in the dispensing chamber between an uppermost row and a bottommost row,
an actuator pivotally mounted on the top of the frame for movement between an opened position permitting access to the uppermost row of the beverage containers and a closed position blocking the access, and
a mechanical lifting mechanism coupled to the actuator and being sized and configured to lift the rows of beverage containers upward within the dispensing chamber in response to pivoting the actuator from the opened position to the closed position.

14. A beverage dispensing apparatus as defined in claim 13
wherein the lifting mechanism includes linkage that deactivates the lifting mechanism until all beverage containers in a given row are dispensed.

15. A beverage dispensing apparatus as defined in claim 13
wherein the lifting mechanism includes linkage that inactivates the lifting mechanism when the bottommost row of beverage containers has been lifted up for access.

16. A method for dispensing a beverage container comprising
providing a beverage dispensing apparatus defining a dispensing chamber sized and configured to hold a number of beverage containers vertically stacked in rows,
pivotally mounting an actuator on the top of the frame for movement between an opened position and a closed position,
pivoting the actuator to the opened position to gain access to the uppermost row of the beverage containers within the dispensing chamber,
pivoting the actuator to the closed position to block the access, and
lifting the rows of beverage containers stepwise upward within the dispensing chamber in response to pivoting the actuator from the opened position to the closed position.

17. A method as defined in claim 16
further including deactivating the lifting until all beverage containers in a given row are dispensed.

18. A method as defined in claim 16
further including inactivating the lifting when the bottommost row of beverage containers has been lifted up for access.
